(19) United States
(12) Patent Application Publication
(10) Pub. No.: US 2012/0181054 A1
(43) Pub. Date: Jul. 19, 2012

(54) Split Junction Box

(76) Inventor: Gary A. Melton, Martinez, GA (US)

(21) Appl. No.: 13/352,483

(22) Filed: Jan. 18, 2012

Related U.S. Application Data
(60) Provisional application No. 61/433,708, filed on Jan. 18, 2011.

(51) Int. Cl. H02G 3/08

(52) U.S. Cl. 174/50

(57) ABSTRACT

An architecture is presented that provides a wiring junction box for enclosing an existing exposed electrical junction without the need to either disrupt the power supply or to disconnect the wires to install the junction box.

### CROSS-REFERENCE

This application claims priority from Provisional Patent Application Ser. No. 61/433,708 filed Jan. 18, 2011.

### FIELD OF THE INVENTION

This invention pertains generally to a wiring junction box, and more particularly to a split junction box for enclosing an existing exposed electrical junction without the need to either disrupt the power supply or to disconnect the wires.

### BACKGROUND

Building codes typically require a junction box to protect electrical wiring connections. Many of these electrical connections are found in attics, crawl spaces, basements, or other hard to access areas. Oftentimes, a homeowner may rewire part of a house without the knowledge of the junction box requirement, thereby resulting in an exposed electrical junction which could result in electrocution or fire. To cover or protect these existing exposed junctions, individuals typically must first shut off power to the applicable circuit so that the junction may be safely disconnected and a junction box properly installed. During warm weather months, attics may reach temperatures well over 100 degrees Fahrenheit. A worker having to wait in such an environment while waiting for someone else to shut off the power may experience conditions that are both exhausting and suffocating. Additionally, an individual working alone will likely have to make several trips between the attic and the electric panel to turn on/off the electricity, thereby greatly increasing the time required to complete the task safely.

Consequently, there is a need for an easier and safer way to install a junction box on an existing exposed wire junction. The present invention discloses a split wiring junction box for encapsulating existing wire connections quickly and in compliance with known and accepted electrical safety requirements. The split wiring junction box allows individuals to encapsulate existing electrical junctions without the need to cut off the power supply and disassemble the wiring connection more efficiently without the discomfort associated with traditional devices.

### SUMMARY

Accordingly, the present invention overcomes the limitations of the prior art by providing a unique and useful electrical junction box adapted for use with an existing installed electrical junction without the need to shut off power to the circuit or to disconnect the wiring that is quick and simple to install.

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a wiring junction enclosure device. The wiring junction enclosure device comprises a first and second base element, wherein the first base element is removably securable to the second base element. The wiring junction enclosure device further comprises a plurality of apertures configured to allow a wire to penetrate the wiring junction enclosure device while securing the wire against lateral movement. Additionally the wiring enclosure junction device functions to completely encapsulate an open wire junction without the need to interrupt the power supply or rewire the junction.

Furthermore in the preferred embodiment of the present invention, the wiring junction enclosure device functions as a wiring junction box for an existing open wire junction. To enclose the existing wire junction, the first base element may be placed underneath and the second base element is aligned with and secured to the first base element from the opposite side, thereby encapsulating the existing open wire junction. The wiring junction box may then be secured to a building structural element, such as a joist or a wall stud, with a fastener. A plurality of wires may penetrate the plurality of aperture elements which hold the plurality of wires in place with friction. Once the existing open wire junction is enclosed, a lid element, which is useful for accessing the interior of said wire junction box, may be positioned over the second base element and secured in place.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an exploded top perspective view of a wiring junction enclosure device in accordance with the disclosed architecture.

FIG. 2 illustrates a side view of the wiring junction enclosure device encapsulating an existing wire junction in accordance with the disclosed architecture.

FIG. 2A illustrates a side view of a cut away portion of the wiring junction enclosure device encapsulating an existing wire junction in accordance with the disclosed architecture.

FIG. 3 illustrates an end view of a wiring junction box with a hinged connection in a closed position.

FIG. 3A illustrates an end view of a wiring junction box with a hinged connection in an open position.

FIG. 4 illustrates an end view of a wiring junction box with a hinged lid in accordance with the disclosed architecture.

FIG. 5 illustrates a top perspective view of an uncovered wiring junction box for use with an electrical junction comprising more than two wires in accordance with the disclosed architecture.

### DETAILED DESCRIPTION

The present invention discloses a wiring junction enclosure device for covering existing exposed electrical junctions to increase safety and meet building code requirements without the need to cut off the power supply or to disassemble any wiring to install the junction box. The preferred embodiment allows a single person to simply and quickly encapsulate an unprotected existing wire connection. The wiring junction enclosure device comprises first and second base elements capable of enclosing at least a wire. The wiring junction enclosure device also comprises a plurality of aperture elements for receiving the at least a wire so that the at least a wire may penetrate the wiring junction enclosure device. Once the at least a wire is encircled, a lid element may be placed atop the second base element thereby completely encapsulating the existing electrical junction, and the wiring junction enclosure device may be attached to a building structural element. The wiring junction enclosure device is especially useful in hard to access areas or uncomfortable environments such as attics, basements, crawl spaces, and the like.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

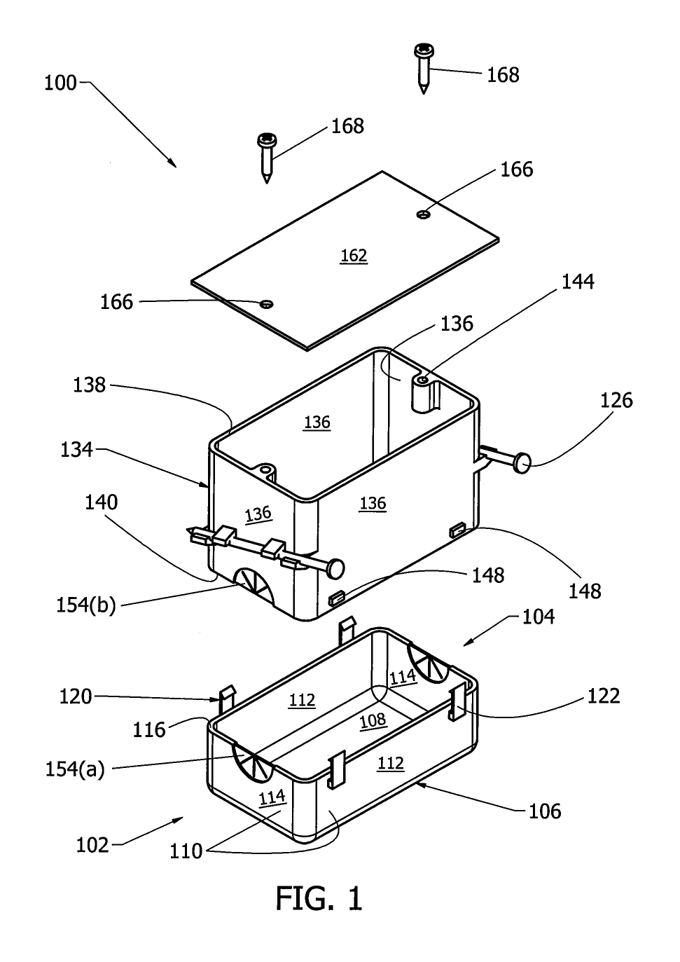

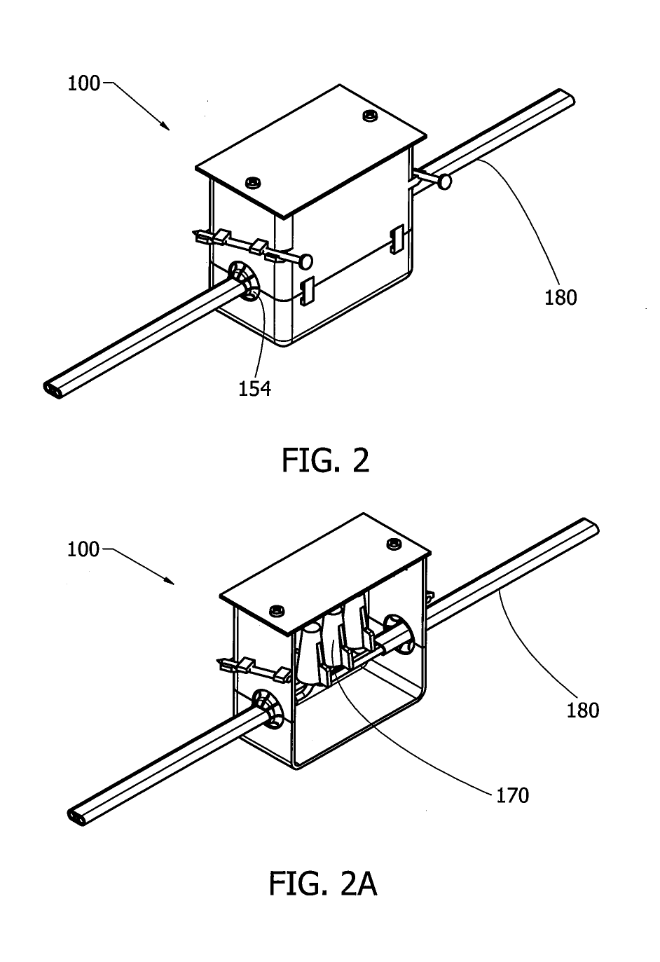

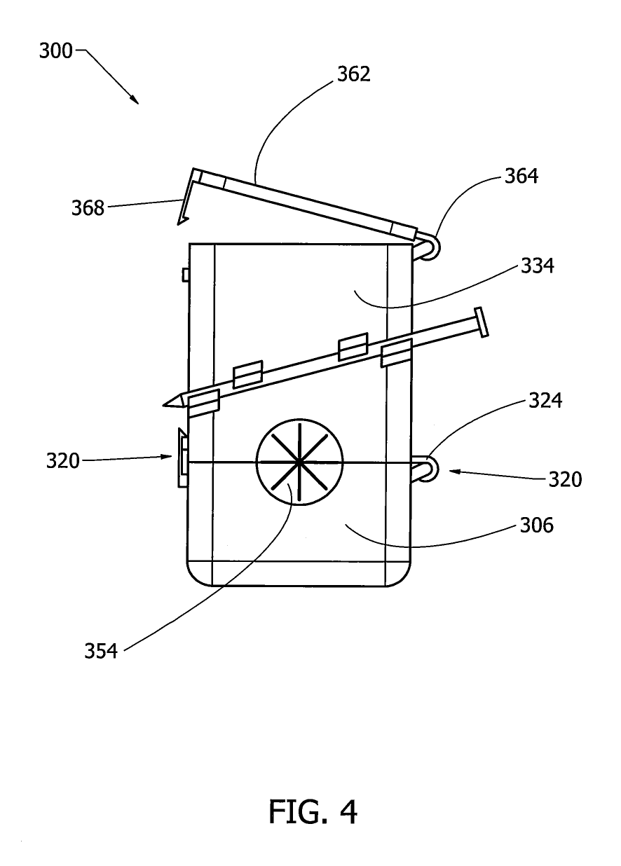

Referring initially to the drawings, FIGS. 1, 2, and 2A illustrate a wiring junction enclosure device 100 for use in protecting an existing exposed wiring junction 170. The wiring junction enclosure device 100 comprises a first base element 106, a second base element 134, and a plurality of aperture elements 154. The plurality of aperture elements 154 are typically located in a first end 102 and a second end 104 of the wiring junction enclosure device 100, so that a wire 180 may penetrate and be secured in place by the plurality of aperture elements 154. While the plurality of aperture elements 154 are preferably two in number, other embodiments, such as the embodiment illustrated in FIG. 4, may number more than two without deviating from the scope of the invention.

The wiring junction enclosure device 100 is preferably constructed from plastic, though it is contemplated that other suitable materials can be used including, without limitation, steel, aluminum, metal alloys, polymers, thermoplastics, poly vinyl chloride, injection molded acrylnitril-butadiene styrene, and the like, without affecting the overall scope of the invention. The wiring junction enclosure device 100 typically comprises a rectangular shape, where the first and second ends 102 and 104 are approximately between 2 and 2½ inches in length, and a pair of adjacent sides (not numbered) are approximately between 3¼^{th} and 4 inches in length. Additionally, the wiring junction enclosure device 100 is typically between 2½ and 3½ inches deep. However, this is not meant as a limitation as the wiring junction enclosure device 100 may be of larger and/or smaller dimensions, without deviating from the scope of the invention. For example, lengths may vary from between 1½ and 6 inches depending on the size of an already installed electrical cable junction 170 requiring encapsulation. As illustrated supra, the wiring junction enclosure device 100 is useful for encapsulating the already installed electrical cable junction 170 which may comprise any connection involving at least one cable such as an insulated conductor, nonmetallic sheathed cable, or any other flexible cable connection that would benefit from encapsulation, such as Ethernet cable, coaxial cable, and the like.

The first base element 106 comprises a rectangular shaped bottom 108 and a peripheral first sidewall element 110 that form a box-like structure. The first peripheral sidewall element 110 comprises a pair of opposite sidewalls 112, a pair of opposite end walls 114, and a top edge 116. The second base element 134 comprises a second sidewall element 136 configured to abut the top edge 116 of the first peripheral sidewall element 110. The second sidewall element 136 comprises a lid edge 138 and a bottom edge 140 designed to abut the top edge 116 of the peripheral first sidewall element 110. Furthermore, the lid edge 138 preferably comprises a plurality of eyelets 144 for receiving a lid connecting element 168, such as a screw for example. While the second base element 134 preferably does not have a top or bottom wall, an embodiment where a second topped base element (not shown) is approximately identical in design to the first base element 106 having a rectangular shaped top comparable to the rectangular shaped bottom 108 is also contemplated.

Preferably, the second base element 134 is removably attached to the first base element 106 once positioned around an existing electrical junction 170. In other words, the first base element 106 may be positioned on one side of an existing electrical junction 170, and the second base element 134 may be positioned from the opposite side so that the bottom edge 140 is placed adjacent to the top edge 116 of the first base element 106, thereby enclosing the existing electrical junction 170 therein. Typically, the peripheral first sidewall element 110 is substantially equal in height to the second sidewall element 134. However, this is not meant as a limitation as the inventor conceives of embodiments where the peripheral first sidewall element 110 and the second sidewall element 136 are not substantially equal in height. For example, the peripheral first sidewall element 110 may be shorter in height to accommodate a shallow wall space as necessary.

The wiring junction enclosure device 100 further comprises a plurality of connecting elements 120 for selectively and removably attaching the second base element 134 to the first base element 106. The plurality of connecting elements 120 preferably comprise a plurality of clip elements 122 located around the perimeter of the peripheral first sidewall element 110, and a plurality of clip holder elements 148 located on the second sidewall element 136. As the second base element 134 is positioned adjacent to the first base element 106, the plurality of clip elements 122 selectively engage the corresponding plurality of clip holder elements 148, thereby forming a connection. To detach the first and second base elements 106 and 134, the plurality of clip elements 122 are selectively disengaged from the plurality of clip holder elements 148.

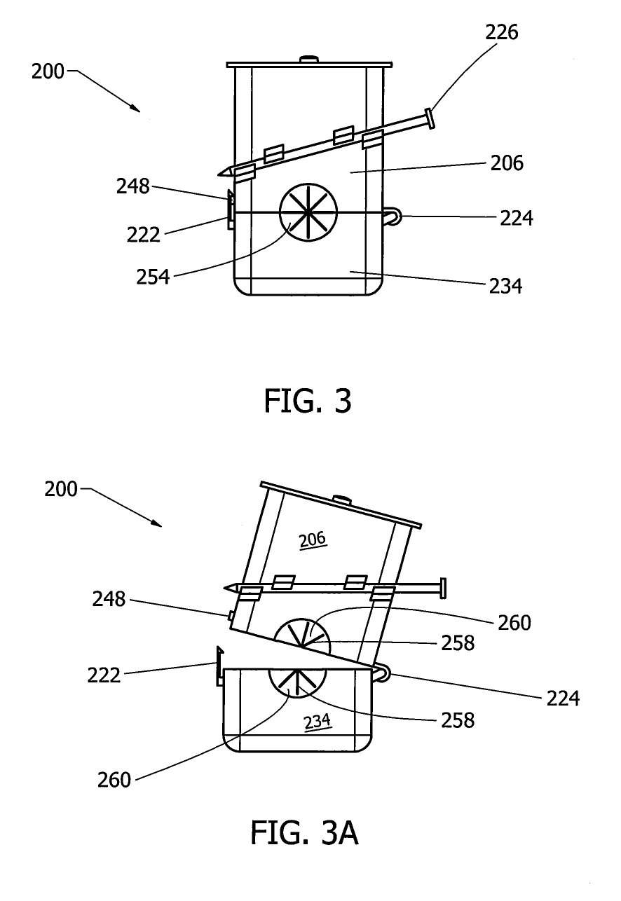

The plurality of connecting elements 120 may comprise fastening clips, J-hook clips, hooks and latches, clamps, spring clips, plastic clips and catches, and the like, and any other fastening system known to one skilled in the art. In addition, an embodiment utilizing hinges as part of the plurality of connecting elements 120 (as seen in FIGS. 3 and 3A) is contemplated.

The wiring junction enclosure device 100 may be secured or attached to a building structural element (not shown) such as a two by four, a wall stud, a beam, and the like. A securing system 126 preferably comprises two nails slideably secured to either the first and second ends 102 and 104 of the first or second base elements 106 and 134 on a diagonal orientation. However, it is contemplated that other methods of attachment known in the art such as screws, clips, pins, and the like may be used in any orientation without affecting the overall scope of the invention. Additionally, at least one knockout element (not shown) as known in the prior art for use in future wiring additions may be located anywhere on the first and/or second base elements 106 and 134.

The plurality of aperture elements 154 each comprise a first half 154(a) and a second half 154(b) that transect the first and second ends 102 and 104 of the wiring junction enclosure element 100 so that the plurality of aperture elements 154 are located partly within both the peripheral first sidewall element 110 and the second sidewall element 136. In other words, the first half 154(a) forms a half circle cut into each of the pair of opposite end walls 114 which mate with the second half 154(b) which forms a half circle cut into the adjacent portion of the second sidewall element 136 so that each of the mated first and second half's 154(a) and 154(b) form a substantially complete circle when the first base element 106 is engaged with the second base element 134. However, this is not meant as a limitation as the plurality of aperture element 154 may comprise other shapes, such as, but not limited to ovals, squares, rectangles, diamonds, and the like.

The plurality of aperture elements 154, if circular, preferably have a diameter of approximately between ¾^{th} and 1¾^{th} inches, however the diameter may range from between ¼^{th} and 3 inches depending on the size of the wire 180 to be encapsulated. The plurality of aperture elements 154 are preferably comprised of plastic or rubber that is penetrable, and splay open when breached by the wire 180. While as seen in FIGS. 2 and 2A, the plurality of aperture elements 154 typically splay outward, however the plurality of aperture elements 154 may extend inwardly as well if desired. Therefore, as the wire 180 is encapsulated, the plurality of aperture elements 154 separate just enough to allow the wire 180 to penetrate while resisting lateral movement of the wire 180 once secured.

A lid element 162, sized to cover the second base element 134 may be attached to the second base element 134. The lid element 162 may comprise a plurality of fastener holes 166 that align with the eyelets 144 on the second base element 134. The lid element 162 is attached to the second base element 134 with a plurality of lid connecting element 168 which typically comprises a plurality of screws or other common fasteners, such as, but not limited to snaps, hooks, and friction elements known in the art. However, the lid element 162 may also be attached by a hinge (as seen in FIG. 4) and/or a plurality of clips similar to the plurality of connecting elements 120 as seen in FIG. 1.

FIGS. 3 and 3A illustrate a wiring junction box 200. The wiring junction box 200 comprises a first base element 206, a second base element 234, and a plurality of aperture elements 254. Additionally, the plurality of aperture elements 254 further comprise a plurality of perforated breakaway portions 258 which allow a wire (not shown) to penetrate the plurality of aperture elements 254. Once penetrated by the wire, the perforated breakaway portions 258 separate on approximately diagonal lines so that the plurality of aperture elements 254 splay open forming a plurality of gripping elements 260 that limit lateral movement of the wire. As illustrated supra in FIGS. 2 and 2A, the plurality of gripping elements 260 typically extend outward, however, the plurality of gripping elements 260 may extend inwardly as well. Therefore, once the wire is encapsulated by the plurality of aperture elements 254, the perforated breakaway portions 258 separate just enough to allow the wire to penetrate, but the plurality of gripping elements 260 resist lateral movement of the wire once secured.

The wiring junction box 200 may further comprise a base hinge element 224 that pivotally connects the second base element 234 to the first base element 206. The base hinge element 224 may be located on any side of the first base element 206 and is integrally hinged to the second base element 234. Furthermore, the base hinge element 224 allows the first and second base elements 206 and 234 to pivot along the base hinge element 224 so that the wiring junction box 200 may move between an open position (as seen in FIG. 3A), and a closed position (as seen in FIG. 3). Opposite the base hinge element 224, a plurality of clip elements 222 may selectively engage with a plurality of clip holder elements 246 to secure the first base element 206 to the second base element 234. Once the wire is secure, the wiring junction box 200 may be secured to a building structural element (not shown) with a plurality of securing elements 226, such as two integrated nails for example.

FIG. 4 illustrates a wiring junction box 300 comprising a first base element 306, a second base element 334, and a plurality of apertures 254. The first base element 306 is pivotally connected to the second base element 334 with a base hinge element 320 and further secured with a plurality of connecting elements 320. Additionally, a lid element 362 is pivotally connected to the second base element 334 with a lid hinge element 364 in a similar manner as how the base hinge element 320 is connected. The lid element 362 is further selectively securable to the second base element 334 with a plurality of lid connecting elements 368 similar to the plurality of connecting elements 120 and the plurality of clip holder elements 148 (as seen in FIGS. 1 and 2).

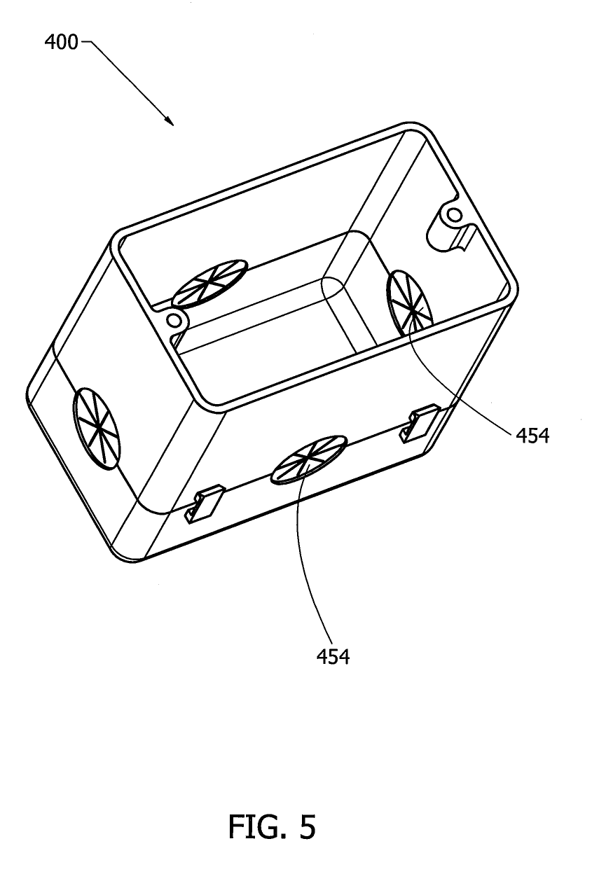

FIG. 5 illustrates a wiring junction box 400 for use with more than two wires (not shown). The wiring junction box 400 comprises a plurality of aperture elements 454 that number more than two. For example, the plurality of aperture elements 454 in this embodiment number four so that the more than two wires may enter the wiring junction box 400 not only from opposite directions, but from other angles as well.

What has been described above includes examples of the disclosed device. It is, of course, not possible to describe every conceivable combination of components and/or methodologies, but one of ordinary skill in the art may recognize that many further combinations and permutations are possible. Accordingly, the novel device is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A wiring junction enclosure device comprising:
a first base element;
a second base element; and
a plurality of aperture elements, wherein each of the plurality of aperture elements may secure at least one wire.

2. The wiring junction enclosure device of claim 1, wherein the wiring junction enclosure device is comprised of at least one of the following materials: steel, metal, metal alloys, plastic, polymers, thermoplastics, and poly vinyl chloride.

3. The wiring junction enclosure device of claim 1, wherein the plurality of aperture elements comprise two aperture elements.

4. The wiring junction enclosure device of claim 1, wherein the plurality of aperture elements is comprised of one of the following materials: rubber, plastic, and metal.

5. The wiring junction enclosure device of claim 1, further comprising at least one knock-out element.

6. The wiring junction enclosure device of claim 1, further comprising a plurality of connecting elements where the second base element is removably secured to the first base element.

7. A wiring junction box for use in protecting an existing junction of at least two electrical wires comprising:
a first base element comprising a rectangular shaped bottom and a peripheral first sidewall element;
a second base element comprising a second sidewall element configured to abut a top edge of the peripheral first sidewall element;
a plurality of aperture elements, wherein the plurality of aperture elements transect a first and second ends of the wiring junction box so that the plurality of aperture elements are positioned partly within both the peripheral first sidewall element and the second sidewall element; and
a lid element removably attachable to the second base element.

8. The wiring junction box of claim 7, wherein the wiring junction box is securable to a building structural element.

9. The wiring junction box of claim 7, further comprising a plurality of connecting elements for selectively attaching the second base element to the first base element.

10. The wiring junction box of claim 9, further comprising a base hinge element pivotally connecting the second base element to the first base element.

11. The wiring junction box of claim 7, further comprising a lid hinge element pivotally connecting the second base element to the lid element.

12. The wiring junction box of claim 7, further comprising a plurality of lid connecting elements for selectively attaching the lid element to the second base element.

13. The wiring junction box of claim 12, wherein the plurality of lid connecting elements comprise snaps, hooks, screws, fasteners, and friction elements.

14. The wiring junction box of claim 7, wherein the plurality of aperture elements comprise four aperture elements.

15. A wiring junction box for use in protecting an already installed electrical cable connection without interruption of electrical power or disconnection of the already installed electrical cable connection comprising:
a first base element comprising a rectangular shaped bottom and a peripheral first sidewall element;
an second base element comprising an second sidewall element configured to abut a top edge of the peripheral first sidewall element, wherein the second base element is removably attachable to the first base element once positioned around a junction of more than one wires;
a plurality of aperture elements comprising a plurality of perforated breakaway portions allowing a flexible cable to penetrate the plurality of aperture elements, wherein the plurality of aperture elements transect a first and second ends of the wiring junction box so that the plurality of aperture elements are positioned partly within both the peripheral first sidewall element and the second sidewall element; and
a lid element removably attached to the upper base element.

16. The wiring junction box of claim 15, wherein the peripheral lower sidewall element is substantially equal in height to the upper sidewall element.

17. The wiring junction box of claim 15, wherein the peripheral lower sidewall element is not substantially equal in height to the upper sidewall element.

18. The wiring junction box of claim 15, the plurality of aperture elements comprise the following shapes: circular, oval, square, rectangular, and diamond.

19. The wiring junction box of claim 15, wherein the perforated breakaway portions form a plurality of gripping elements when the plurality of aperture elements are penetrated.

20. The wiring junction box of claim 19, wherein the plurality of gripping elements extend outwardly or inwardly when penetrated so that the flexible cable resists lateral movement through the plurality of gripping elements.
